(19) United States
(12) Patent Application Publication
(10) Pub. No.: US 2020/0173888 A1
(43) Pub. Date: Jun. 4, 2020

(54) MANAGEMENT SYSTEM, MANAGEMENT DEVICE, MANAGEMENT METHOD, AND MANAGEMENT PROGRAM

(71) Applicant: SUMITOMO ELECTRIC INDUSTRIES, LTD., Osaka-shi, Osaka (JP)

(72) Inventor: Daigo MURATA, Osaka-shi (JP)

(73) Assignee: SUMITOMO ELECTRIC INDUSTRIES, LTD., Osaka-shi, Osaka (JP)

(21) Appl. No.: 16/636,393

(22) PCT Filed: Jul. 13, 2018
(86) PCT No.: PCT/JP2018/026450

§ 371 Date: Feb. 4, 2020

(30) Foreign Application Priority Data
Aug. 8, 2017 (JP) 2017-153236

(51) Int. Cl. G01M 99/00; H04B 7/15

(52) U.S. Cl. CPC G01M 99/005; H04W 88/02; H04B 7/15

(57) ABSTRACT

A management system includes: a first wireless terminal device configured to acquire and transmit measurement information indicating a result of measurement for target equipment; a second wireless terminal device configured to acquire and transmit equipment information about operation of the target equipment; and a management device configured to acquire the measurement information and the equipment information and perform processing of extracting a part of the measurement information on the basis of the equipment information.

### TECHNICAL FIELD

The present invention relates to a management system, a management device, a management method, and a management program.

This application claims priority on Japanese Patent Application No. 2017-153236 filed on Aug. 8, 2017, the entire content of which is incorporated herein by reference.

### BACKGROUND ART

Japanese Laid-Open Patent Publication No. 2006-163517 (PATENT LITERATURE 1) describes the following abnormality detection device. That is, the abnormality detection device is an abnormality detection device having: detection means provided to a monitor target; and calculation means which diagnoses the state of the monitor target through a neural network on the basis of detection data from the detection means, wherein the calculation means forms a model of the neural network by use of predetermined model creation data, diagnoses the state of the monitor target on the basis of the detection data by use of the model of the neural network, adds as an intermediate layer an input vector based on the detection data at a predetermined time point to update the model of the neural network, and after the update, diagnoses the state of the monitor target by use of the updated model of the neural network.

### CITATION LIST

### Patent Literature

PATENT LITERATURE 1: Japanese Laid-Open Patent Publication No. 2006-163517

### SUMMARY OF INVENTION

(1) A management system of the present disclosure includes: a first wireless terminal device configured to acquire and transmit measurement information indicating a result of measurement for target equipment; a second wireless terminal device configured to acquire and transmit equipment information about operation of the target equipment; and a management device configured to acquire the measurement information and the equipment information and perform processing of extracting a part of the measurement information on the basis of the equipment information.

(7) A management device of the present disclosure includes: an acquisition unit configured to acquire measurement information indicating a result of measurement for target equipment, and equipment information about operation of the target equipment; and a processing unit configured to perform processing of extracting a part of the measurement information acquired by the acquisition unit, on the basis of the equipment information acquired by the acquisition unit.

(8) A management method of the present disclosure is a management method in a management system including a first wireless terminal device, a second wireless terminal device, and a management device, the management method including the steps of: the first wireless terminal device acquiring and transmitting measurement information indicating a result of measurement for target equipment; the second wireless terminal device acquiring and transmitting equipment information about operation of the target equipment; and the management device acquiring the measurement information and the equipment information and performing processing of extracting a part of the received measurement information on the basis of the acquired equipment information.

(9) A management program of the present disclosure is a management program for use in a management device, the management program causing a computer to function as: an acquisition unit configured to acquire measurement information indicating a result of measurement for target equipment, and equipment information about operation of the target equipment; and a processing unit configured to perform processing of extracting a part of the measurement information acquired by the acquisition unit, on the basis of the equipment information acquired by the acquisition unit.

One mode of the present disclosure can be realized not only as a management system including such a characteristic processing unit but also as a program for causing a computer to execute such characteristic processing.

One mode of the present disclosure can be realized not only as a management device including such a characteristic processing unit but also as a management method including steps of such characteristic processing and as a semiconductor integrated circuit that realizes a part or the entirety of the management device.

### BRIEF DESCRIPTION OF DRAWINGS

FIG. 1 is a diagram showing the configuration of a management system according to an embodiment of the present disclosure.

FIG. 2 is a diagram showing the configuration of a management device according to the embodiment of the present disclosure.

FIG. 3 shows a measurement result based on plural pieces of measurement information received by the management device shown in FIG. 2.

FIG. 4 shows an example of state change of equipment information in the management device shown in FIG. 2.

FIG. 5 shows a measurement result based on one or plural pieces of measurement information extracted by the management device shown in FIG. 2.

FIG. 6 illustrates an example (first example) of a method for detecting abnormality by the management device according to the embodiment of the present disclosure.

FIG. 7 illustrates an example (second example) of a method for detecting abnormality by the management device according to the embodiment of the present disclosure.

FIG. 8 is a sequence chart showing an example of flow of operation of the management system according to the embodiment of the present disclosure.

FIG. 9 is a diagram showing the configuration of a management system according to modification 1 of the embodiment of the present disclosure.

FIG. 10 shows a measurement result based on equipment information received by the management device shown in FIG. 9.

### DESCRIPTION OF EMBODIMENTS

Conventionally, devices for monitoring target equipment and the like provided in plants have been developed.

### Problems to be Solved by the Present Disclosure

The device as described in PATENT LITERATURE 1 above can detect abnormality that has occurred in target equipment, on the basis of a result of measurement for the target equipment, without using manpower.

However, such measurement for target equipment is performed in not only a period in which the target equipment is operating but also a period in which the operation is stopped. Then, in a case where a measurement result during a period in which the target equipment is operating and a measurement result during a period in which the operation of the target equipment is stopped are both included in data used for detecting abnormality, there is a possibility that detection for abnormality cannot be accurately performed. Further, in this case, calculation processing is performed on unnecessary data.

The present disclosure has been made to solve the above problem, and an object of the present disclosure is to provide a management system, a management device, a management method, and a management program that are capable of favorably performing processing for measurement information about target equipment.

### Effects of the Present Disclosure

According to the present disclosure, processing for measurement information about target equipment can be favorably performed.

### Description of Embodiment of the Present Disclosure

First, contents of embodiments of the present disclosure are listed and described.

(1) A management system according to the embodiment of the present disclosure is a management system including: a first wireless terminal device configured to acquire and transmit measurement information indicating a result of measurement for target equipment; a second wireless terminal device configured to acquire and transmit equipment information about operation of the target equipment; and a management device configured to acquire the measurement information and the equipment information and perform processing of extracting a part of the measurement information on the basis of the equipment information.

With this configuration, the management device can recognize the period in which the target equipment is operating, on the basis of the equipment information, and can selectively extract measurement information including the measurement result corresponding to this period. Thus, abnormality detection for the target equipment can be performed with higher accuracy, using the extracted measurement information. In addition, calculation processing for unnecessary data can be avoided, and thus processing load can be reduced. Therefore, it is possible to favorably perform processing for measurement information indicating a measurement result regarding the target equipment.

(2) Preferably, the second wireless terminal device includes a contact, and information that allows recognition of operation start and operation stop of the target equipment is given as the equipment information to the contact from outside of the second wireless terminal device.

With this configuration, it is possible to easily detect the operation start timing and the operation stop timing of the target equipment on the basis of the state of the contact indicated by the information given from the outside.

(3) More preferably, the management device performs processing of extracting a part of the measurement information on the basis of a time at which the equipment information that allows recognition of operation start of the target equipment has been acquired, and a time at which the equipment information that allows recognition of operation stop of the target equipment has been acquired.

With this configuration, it is possible to detect the operation start timing and the operation stop timing of the target equipment in the management device without performing time measurement in the second wireless terminal device, the relay which relays information between the second wireless terminal device and the management device, or the like.

(4) More preferably, the management system further includes one or a plurality of relays configured to relay information between the second wireless terminal device and the management device, wherein the relay receives the equipment information from the second wireless terminal device, adds time information to the received equipment information, and transmits resultant equipment information to another device, and the management device performs processing of extracting a part of the measurement information on the basis of the time information included in the equipment information that allows recognition of operation start of the target equipment, and the time information included in the equipment information that allows recognition of operation stop of the target equipment.

For example, in a configuration in which the operation start timing and the operation stop timing of the target equipment are detected using the time at which the equipment information is received by the management device, if a long time is required until the equipment information arrives at the management device, error between the operation start timing and the operation stop timing detected by the management device and the actual operation start timing and operation stop timing increases. In contrast, in the configuration of using the time at which the equipment information has been received by the relay as described above, such error is reduced, and the operation start timing and the operation stop timing of the target equipment can be detected with higher accuracy.

(5) Preferably, the equipment information indicates a result obtained by performing, for the target equipment, a different type of measurement from the measurement indicated by the measurement information, and the management device performs processing of extracting a part of the measurement information on the basis of a result of comparison between a measurement result indicated by the equipment information and a predetermined threshold.

With this configuration, it is possible to use a certain type of measurement information for the timing setting for the processing of extracting measurement information about the target.

(6) Preferably, the management device detects abnormality of the target equipment on the basis of the extracted information.

Owing to the configuration in which the management device detects abnormality of the target equipment as described above, it is not necessary to separately provide another device for detecting abnormality.

(7) A management device according to the embodiment of the present disclosure includes: an acquisition unit configured to acquire measurement information indicating a result of measurement for target equipment, and equipment information about operation of the target equipment; and a processing unit configured to perform processing of extracting a part of the measurement information acquired by the acquisition unit, on the basis of the equipment information acquired by the acquisition unit.

With this configuration, the management device can recognize the period in which the target equipment is operating, on the basis of the equipment information, and can selectively extract measurement information including the measurement result corresponding to this period. Thus, abnormality detection for the target equipment can be performed with higher accuracy, using the extracted measurement information. In addition, calculation processing for unnecessary data can be avoided, and thus processing load can be reduced. Therefore, it is possible to favorably perform processing for measurement information indicating a measurement result regarding the target equipment.

(8) A management method according to the embodiment of the present disclosure is a management method in a management system including a first wireless terminal device, a second wireless terminal device, and a management device, the management method including the steps of: the first wireless terminal device acquiring and transmitting measurement information indicating a result of measurement for target equipment; the second wireless terminal device acquiring and transmitting equipment information about operation of the target equipment; and the management device acquiring the measurement information and the equipment information and performing processing of extracting a part of the received measurement information on the basis of the acquired equipment information.

With this method, the management device can recognize the period in which the target equipment is operating, on the basis of the equipment information, and can selectively extract measurement information including the measurement result corresponding to this period. Thus, abnormality detection for the target equipment can be performed with higher accuracy, using the extracted measurement information. In addition, calculation processing for unnecessary data can be avoided, and thus processing load can be reduced. Therefore, it is possible to favorably perform processing for measurement information indicating a measurement result regarding the target equipment.

(9) A management program according to the embodiment of the present disclosure is a management program for use in a management device, the management program causing a computer to function as: an acquisition unit configured to acquire measurement information indicating a result of measurement for target equipment, and equipment information about operation of the target equipment; and a processing unit configured to perform processing of extracting a part of the measurement information acquired by the acquisition unit, on the basis of the equipment information acquired by the acquisition unit.

With this configuration, the management device can recognize the period in which the target equipment is operating, on the basis of the equipment information, and can selectively extract measurement information including the measurement result corresponding to this period. Thus, abnormality detection for the target equipment can be performed with higher accuracy, using the extracted measurement information. In addition, calculation processing for unnecessary data can be avoided, and thus processing load can be reduced. Therefore, it is possible to favorably perform processing for measurement information indicating a measurement result regarding the target equipment.

Hereinafter, embodiments of the present disclosure will be described with reference to the drawings. In the drawings, the same or corresponding parts are denoted by the same reference characters, and description thereof is not repeated. At least some parts of the embodiments described below may be combined together as desired.

<Configuration and Basic Operation>

[Entire Configuration]

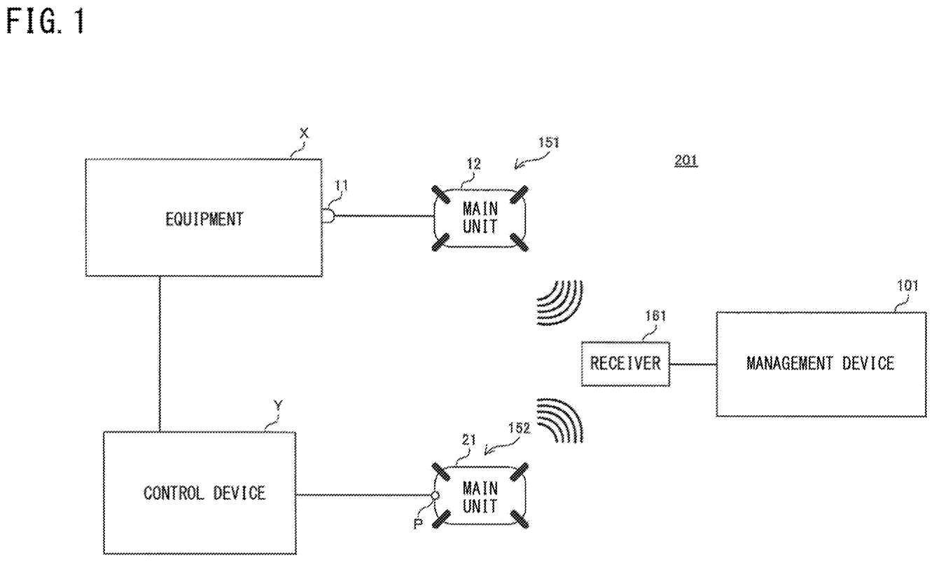

FIG. 1 is a diagram showing the configuration of a management system according to the embodiment of the present disclosure.

With reference to FIG. 1, a management system 201 includes a management device 101, a first wireless terminal device 151, a second wireless terminal device 152, and a receiver (relay) 161.

The first wireless terminal device 151 is of a type that operates by a battery, for example, and is attached to target equipment X provided in a target facility such as a factory. The target equipment X is an apparatus such as a motor. The first wireless terminal device 151 constantly performs measurement for the target equipment X, and transmits measurement information indicating a measurement result to a receiver 161 via wireless communication.

More specifically, the first wireless terminal device 151 includes a detection element 11 attached to the target equipment X, and a main unit 12. The detection element 11 constantly measures, for example, vibration of the target equipment X, and outputs a measurement result to the main unit 12. The main unit 12 transmits measurement information indicating the measurement result received from the detection element 11, to the receiver 161.

The first wireless terminal device 151 may be configured without the detection element 11. In this case, the first wireless terminal device 151 acquires a result of measurement for the target equipment X performed by another device, and transmits measurement information indicating the acquired measurement result, to the receiver 161.

The second wireless terminal device 152 is of a type that operates by a battery, for example, and is connected via a wire to a control device Y which controls operation of the target equipment X. The second wireless terminal device 152 acquires equipment information about operation of the target equipment X, and transmits the acquired equipment information to the receiver 161 via wireless communication.

Specifically, the second wireless terminal device 152 is a contact measurement device that includes a main unit 21 and a contact P and measures the open/close state of the contact P.

When, for example, operated by an administrator, the control device Y transmits an operation start command for starting operation of the target equipment X or an operation stop command for stopping operation of the target equipment X, to the target equipment X. When having received the operation start command from the control device Y, the target equipment X starts operation, and when having received the operation stop command from the control device Y, the target equipment X stops operation.

Information that allows recognition of operation start and operation stop of the target equipment X is given as the equipment information to the contact P from the control device Y.

More specifically, when transmitting the operation start command to the target equipment X, the control device Y outputs, to the contact P, a signal for switching the contact P of the second wireless terminal device 152 from an opened state to a closed state, for example. In addition, when transmitting the operation stop command to the target equipment X, the control device Y outputs, to the contact P, a signal for switching the contact P from a closed state to an opened state, for example.

When the state of the contact P has been switched, the main unit 21 of the second wireless terminal device 152 transmits information indicating the state of the contact P, as the equipment information, to the receiver 161.

Specifically, when the target equipment X has started operation, i.e., when the contact P has been switched to a closed state, the main unit 21 transmits contact information indicating “1” as the equipment information to the receiver 161. In addition, when the target equipment X has stopped operation, i.e., when the contact P has been switched to an opened state, the main unit 21 transmits contact information indicating “0” as the equipment information to the receiver 161.

The receiver 161 is connected to the management device 101 via a wire, for example. The receiver 161 transmits the measurement information from the first wireless terminal device 151 and the equipment information from the second wireless terminal device 152, to the management device 101.

When having received the measurement information and the equipment information transmitted from the receiver 161, the management device 101 performs filtering of the measurement information on the basis of the equipment information. That is, the management device 101 performs processing of extracting a part of the received measurement information on the basis of the received equipment information. Then, the management device 101 detects abnormality of the target equipment X on the basis of the extracted information.

The management device 101 may have the following configuration regarding acquisition of the measurement information and the equipment information. That is, the receiver 161 stores the measurement information from the first wireless terminal device 151 and the equipment information from the second wireless terminal device 152. Then, the management device 101 reads the measurement information and the equipment information stored in a storage unit or the like of the receiver 161, at regular or irregular intervals.

[Management Device]

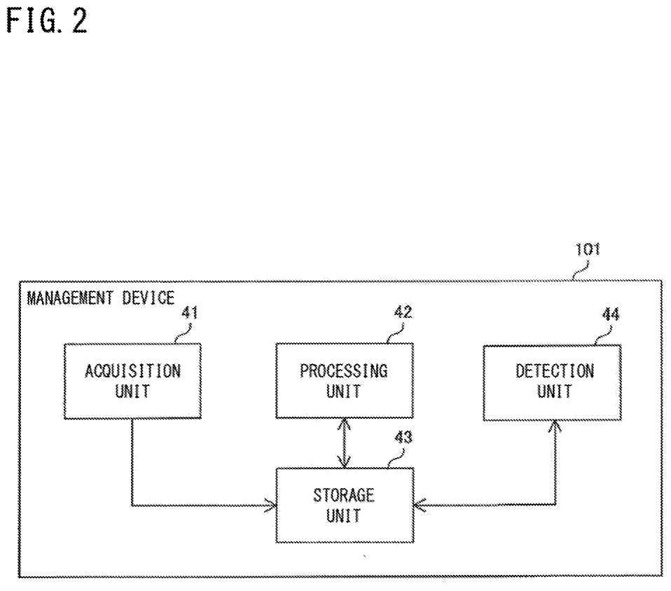

FIG. 2 is a diagram showing the configuration of the management device according to the embodiment of the present disclosure.

With reference to FIG. 2, the management device 101 includes an acquisition unit 41, a processing unit 42, a storage unit 43, and a detection unit 44.

When having received the measurement information transmitted from the receiver 161, the acquisition unit 41 stores the received measurement information and the present time in the storage unit 43. In addition, when having received the equipment information transmitted from the receiver 161, the acquisition unit 41 stores the received equipment information and the present time in the storage unit 43. Thus, pairs of the measurement information and the present times, and pairs of the equipment information and the present times, are accumulated in the storage unit 43.

The processing unit 42 performs processing of extracting some of the plural pieces of measurement information stored in the storage unit 43, at a timing based on the equipment information received by the acquisition unit 41.

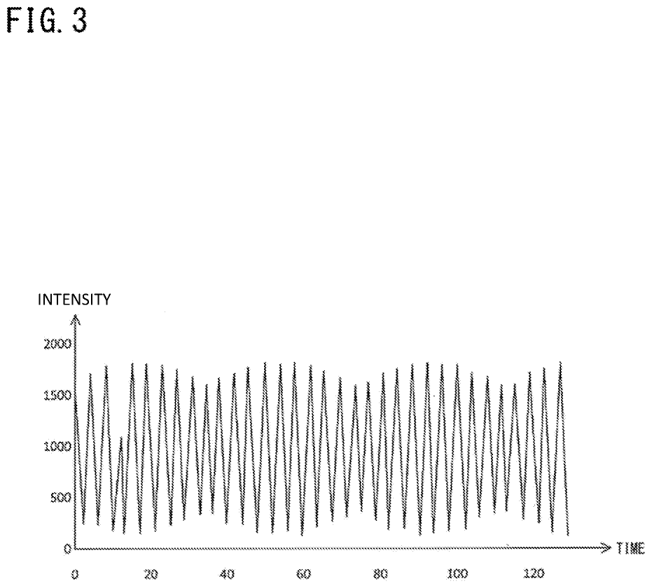

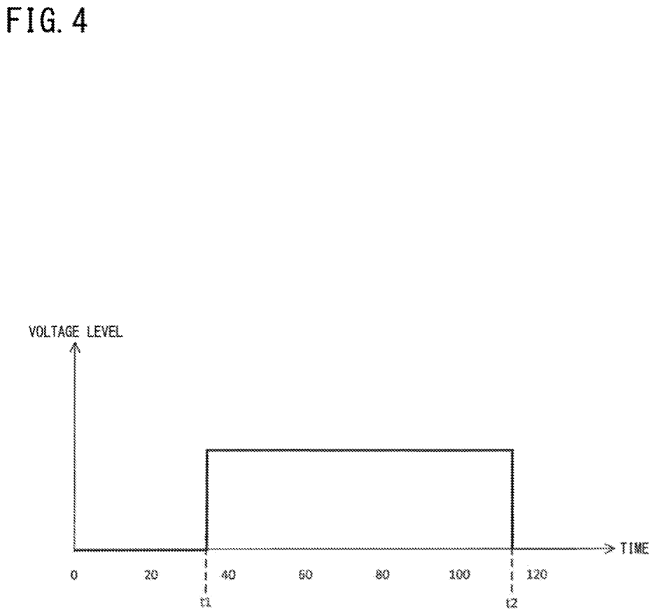

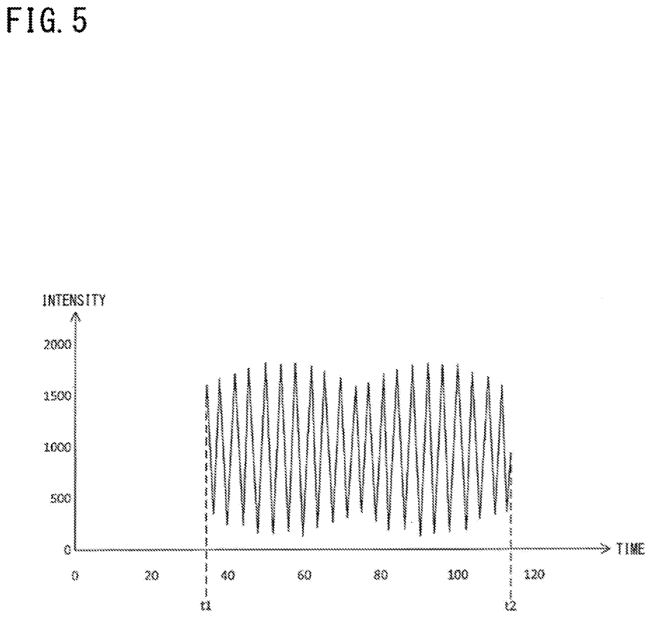

FIG. 3 shows a measurement result based on plural pieces of measurement information received by the management device shown in FIG. 2. FIG. 4 shows an example of state change of the equipment information in the management device shown in FIG. 2. FIG. 5 shows a measurement result based on one or plural pieces of measurement information extracted by the management device shown in FIG. 2.

In the graphs shown in FIG. 3 and FIG. 5, the horizontal axis indicates time, and the vertical axis indicates the vibration intensity of the target equipment X. In the graph shown in FIG. 4, the horizontal axis indicates time, and the vertical axis indicates the voltage level of the equipment information.

With reference to FIG. 3 to FIG. 5, the processing unit 42 detects the operation start timing and the operation stop timing of the target equipment X on the basis of the plural pieces of equipment information stored in the storage unit 43, for example.

Specifically, as shown in FIG. 4, it is assumed that, at time t1, the acquisition unit 41 receives contact information indicating “1” transmitted from the receiver 161, and at time t2, the acquisition unit 41 receives the contact information indicating “0” transmitted from the receiver 161. In this case, the processing unit 42 detects the time t1 as the operation start timing of the target equipment X, and detects the time t2 as the operation stop timing of the target equipment X.

In addition, as shown in FIG. 5, the processing unit 42 extracts one or plural pieces of measurement information corresponding to the times included in the period from time t1 to time t2, from among the plural pieces of measurement information stored in the storage unit 43. That is, each piece of measurement information extracted by the processing unit 42 indicates the measurement result for the target equipment X during a period in which the target equipment X is operating.

Then, the processing unit 42 stores extraction information including the extracted one or plural pieces of measurement information, in the storage unit 43.

With reference to FIG. 2 again, the detection unit 44 acquires the extraction information stored in the storage unit 43, at regular or irregular intervals, and detects abnormality of the target equipment X on the basis of the acquired extraction information. The detection unit 44 can detect, for example, failure or deterioration of the target equipment X, in abnormality detection for the target equipment X.

### Specific Example 1 of Abnormality Detection

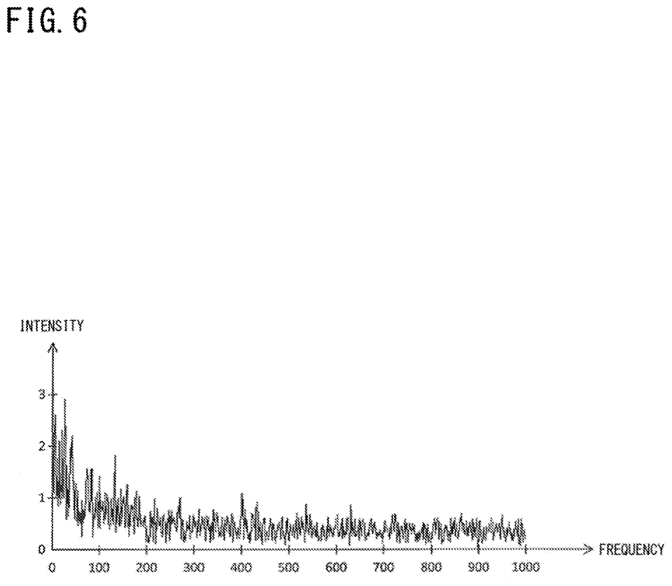

FIG. 6 illustrates an example (first example) of the method for detecting abnormality by the management device according to the embodiment of the present disclosure. In the graph shown in FIG. 6, the horizontal axis indicates the frequency, and the vertical axis indicates the signal intensity at each frequency.

With reference to FIG. 6, for example, the detection unit 44 performs component analysis on the measurement result indicated by the extraction information. That is, the detection unit 44 determines whether or not abnormality has occurred in the target equipment X, on the basis of the frequency distribution characteristics of the waveform shown in FIG. 5.

More specifically, for example, the storage unit 43 stores, as reference data, a result of frequency analysis on a waveform representing the vibration intensity of the target equipment X in a state in which the target equipment X is operating normally. The detection unit 44, for example, compares a singular point of the graph of the reference data and a singular point of the graph obtained by performing frequency analysis on the measurement result indicated by the extraction information, and thus can determine whether or not abnormality has occurred in the target equipment X.

### Specific Example 2 of Abnormality Detection

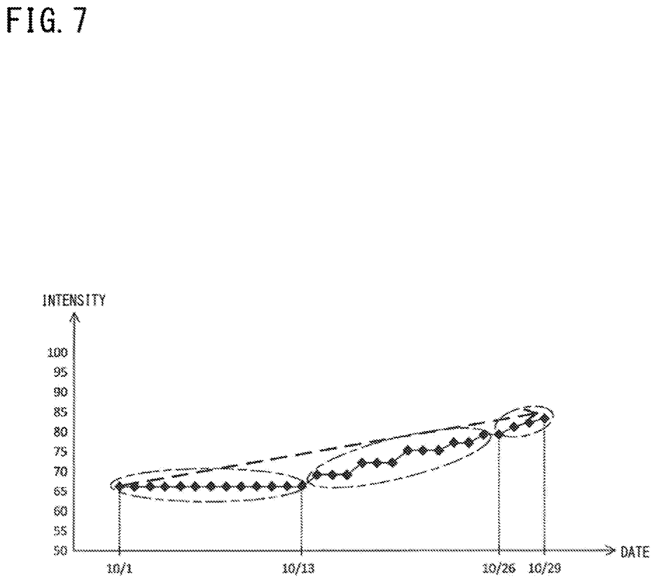

FIG. 7 illustrates an example (second example) of the method for detecting abnormality by the management device according to the embodiment of the present disclosure. In the graph shown in FIG. 7, the horizontal axis indicates the date, and the vertical axis indicates the vibration intensity of the target equipment X.

With reference to FIG. 7, instead of performing frequency analysis, for example, the detection unit 44 may acquire the graph representing the vibration intensity for each date on the basis of the measurement result indicated by the extraction information, and may determine whether or not abnormality has occurred in the target equipment X, on the basis of the graph.

More specifically, for example, the detection unit 44 acquires the extraction information for one day from the storage unit 43, and calculates the average value of the vibration intensity per unit time on the basis of the acquired extraction information. Then, the detection unit 44 stores the calculated average value in association with the date, in the storage unit 43.

In addition, for example, as shown in FIG. 7, the detection unit 44 generates a graph representing the average value of the vibration intensity for each date, and determines whether or not abnormality has occurred in the target equipment X, using the value of the graph and an absolute reference value. For example, the detection unit 44 determines whether or not abnormality has occurred in the target equipment X, using, as a reference value, the amount of change in the vibration intensity in a case where the target equipment X is operating normally.

Specifically, it is assumed that, during a period from October 1 to October 13, the target equipment X has been operating normally, and the amount of change in the average value of the vibration intensity during this period is approximately zero. In this case, the detection unit 44 sets the reference value to zero, for example.

Then, for example, it is assumed that, during a period from October 13 to October 26, an event in which the difference between the reference value and the amount of change from the average value of the vibration intensity on the previous date to the average value of the vibration intensity on the next date is equal to or greater than a predetermined value, has occurred once every several days. In this case, for example, the detection unit 44 determines that, during this period, the target equipment X is in a state of requiring attention, i.e., abnormality is highly likely to occur in the target equipment X.

In addition, for example, it is assumed that, during a period from October 26 to October 29, an event in which the difference between the reference value and the amount of change from the average value of the vibration intensity on the previous date to the average value of the vibration intensity on the next date is equal to or greater than the predetermined value, has occurred several consecutive times. In this case, for example, the detection unit 44 determines that abnormality has occurred in the target equipment X.

The detection unit 44 may determine whether or not abnormality has occurred in the target equipment X, by comparing the average value of the vibration intensity of the target equipment and a relative reference value.

Specifically, for example, if the slope of a graph connecting the average value of the vibration intensity on October 1 and the average value of the vibration intensity on a certain day is smaller than a first predetermined value, the detection unit 44 determines that abnormality has not occurred in the target equipment X. In addition, for example, if the slope of the graph is equal to or greater than the first predetermined value and is smaller than a second predetermined value, the detection unit 44 determines that the target equipment X is in a state of requiring attention. In addition, for example, if the slope of the graph is equal to or greater than the second predetermined value, the detection unit 44 determines that abnormality has occurred in the target equipment X.

The management device 101 may be configured without the detection unit 44. In this case, the management device 101 transmits the extraction information stored in the storage unit 43, to another abnormality detection device. The abnormality detection device receives the extraction information transmitted from the management device 101, and detects abnormality of the target equipment X on the basis of the received extraction information.

<Flow of Operation>

Each device in the management system 201 includes a computer, and a calculation processing unit such as a CPU in the computer reads a program including some or all of the steps in a sequence chart shown below, from a memory (not shown), and executes the program. The programs for the plurality of devices can be each installed from outside. The programs for the plurality of devices are each distributed in a state of being stored in a storage medium.

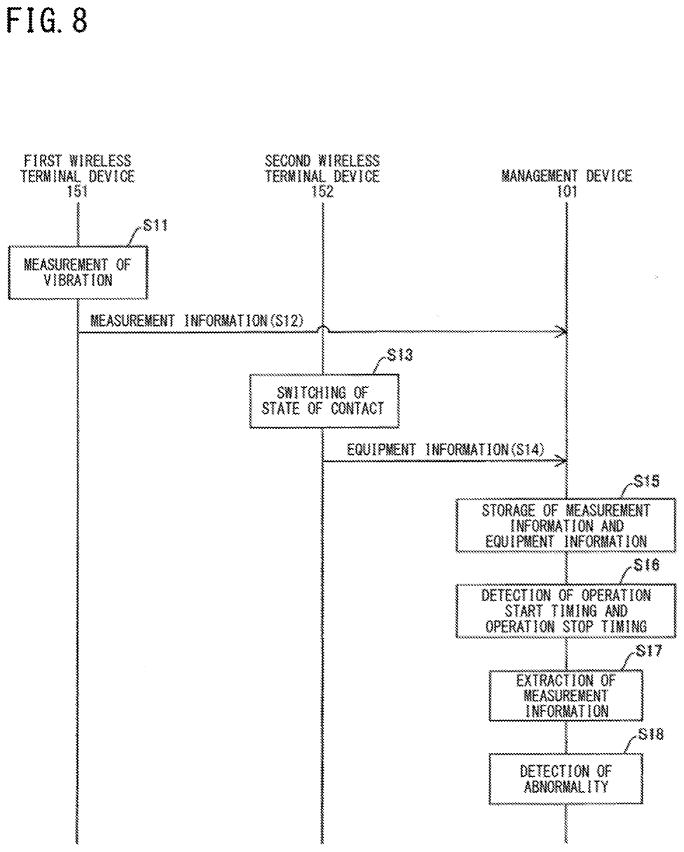

FIG. 8 is a sequence chart showing an example of flow of operation of the management system according to the embodiment of the present disclosure.

With reference to FIG. 8, first, the first wireless terminal device 151 constantly measures vibration of the target equipment X (step S11), and transmits measurement information indicating a measurement result to the management device 101 via the receiver 161 (step S12).

Next, when the state of the contact P of the second wireless terminal device 152 has been switched (step S13), the second wireless terminal device 152 transmits equipment information indicating the state of the contact P to the management device 101 via the receiver 161 (step 14).

Next, the management device 101 receives the measurement information transmitted from the first wireless terminal device 151 and the equipment information transmitted from the second wireless terminal device 152, and stores the received measurement information and equipment information (step S15).

Next, the management device 101 detects the operation start timing and the operation stop timing of the target equipment X on the basis of the stored plural pieces of equipment information (step S16).

Next, on the basis of the detected operation start timing and operation stop timing, the management device 101 extracts, from among the plural pieces of measurement information, one or plural pieces of measurement information indicating measurement results during the period in which the target equipment X is operating (step S17).

Then, the management device 101 detects abnormality in the target equipment X on the basis of extraction information including the extracted one or plural pieces of measurement information (step S18).

It is noted that switching of the state of the contact P (step S13) and transmission of the equipment information by the second wireless terminal device 152 (step S14) may be performed before measurement by the first wireless terminal device 151 (step S11) and transmission of the measurement information (step S12).

Incidentally, the device as described in PATENT LITERATURE 1 above can detect abnormality that has occurred in target equipment, on the basis of a result of measurement for the target equipment, without using manpower.

However, such measurement for target equipment is performed in not only a period in which the target equipment is operating but also a period in which the operation is stopped. Then, in a case where a measurement result during a period in which the target equipment is operating and a measurement result during a period in which the operation of the target equipment is stopped are both included in data used for detecting abnormality, there is a possibility that detection for abnormality cannot be accurately performed. Further, in this case, calculation processing is performed on unnecessary data.

Considering the above, for example, it is conceivable that, when stopping operation of the target equipment, the control device controls a transmitter that wirelessly transmits a measurement result about the target equipment, so as to stop transmission of the measurement result. However, in this case, it is necessary to make wiring between the control device and the transmitter, thus causing a problem of cost increase and the like.

In contrast, in the management system 201 according to the embodiment of the present disclosure, the first wireless terminal device 151 acquires and transmits the measurement information indicating a result of measurement for the target equipment X. In addition, the second wireless terminal device 152 acquires and transmits the equipment information about operation of the target equipment X. Further, the management device 101 acquires the measurement information and the equipment information, and performs processing of extracting a part of the acquired measurement information on the basis of the acquired equipment information.

With this configuration, the management device 101 can recognize the period in which the target equipment X is operating, on the basis of the equipment information, and can selectively extract measurement information including the measurement result corresponding to this period. Thus, abnormality detection for the target equipment X can be performed with higher accuracy, using the extracted measurement information. In addition, calculation processing for unnecessary data can be avoided, and thus processing load can be reduced. Therefore, it is possible to favorably perform processing for measurement information indicating a measurement result regarding the target equipment X.

In addition, in the management system 201 according to the embodiment of the present disclosure, the second wireless terminal device 152 includes the contact P. Information that allows recognition of operation start and operation stop of the target equipment X is given as the equipment information to the contact P from the control device Y which is outside the second wireless terminal device 152.

With this configuration, it is possible to easily detect the operation start timing and the operation stop timing of the target equipment X on the basis of the state of the contact P indicated by the information given from the control device Y.

In addition, in the management system 201 according to the embodiment of the present disclosure, the management device 101 performs processing of extracting a part of the measurement information on the basis of the time at which the equipment information that allows recognition of operation start of the target equipment X has been acquired, and the time at which the equipment information that allows recognition of operation stop of the target equipment X has been acquired.

With this configuration, it is possible to detect the operation start timing and the operation stop timing of the target equipment X in the management device 101 without performing time measurement in the second wireless terminal device 152, the receiver 161 which relays information between the second wireless terminal device 152 and the management device 101, or the like.

In addition, in the management system 201 according to the embodiment of the present disclosure, the management device 101 detects abnormality of the target equipment X on the basis of the extracted information.

Owing to the configuration in which the management device 101 detects abnormality of the target equipment X as described above, it is not necessary to separately provide another device for detecting abnormality.

In addition, in the management device 101 according to the embodiment of the present disclosure, the acquisition unit 41 acquires measurement information indicating a result of measurement for the target equipment X, and equipment information about operation of the target equipment X. Further, the processing unit 42 performs processing of extracting a part of the measurement information acquired by the acquisition unit 41, on the basis of the equipment information acquired by the acquisition unit 41.

With this configuration, the management device 101 can recognize a period in which the target equipment X is operating, on the basis of the equipment information, and can selectively extract the measurement information including the measurement result corresponding to this period. Thus, abnormality detection for the target equipment X can be performed with higher accuracy, using the extracted measurement information. In addition, calculation processing for unnecessary data can be avoided, and thus processing load can be reduced. Therefore, it is possible to favorably perform processing for measurement information indicating a measurement result regarding the target equipment X.

In addition, in the management system 201 according to the embodiment of the present disclosure, first, the first wireless terminal device 151 acquires and transmits measurement information indicating a result of measurement for the target equipment X. Next, the second wireless terminal device 152 acquires and transmits equipment information about operation of the target equipment X. Next, the management device 101 acquires the measurement information and the equipment information, and performs processing of extracting a part of the measurement information on the basis of the equipment information.

With this method, the management device 101 can recognize a period in which the target equipment X is operating, on the basis of the equipment information, and can selectively extract the measurement information including the measurement result corresponding to this period. Thus, abnormality detection for the target equipment X can be performed with higher accuracy, using the extracted measurement information. In addition, calculation processing for unnecessary data can be avoided, and thus processing load can be reduced. Therefore, it is possible to favorably perform processing for measurement information indicating a measurement result regarding the target equipment X.

### Modification 1

In the example shown in FIG. 1, the second wireless terminal device 152 in the management system 201 transmits a signal indicating the state of the contact P, as the equipment information. However, without limitation to such a configuration, the second wireless terminal device may transmit information indicating a result of measurement for the target equipment X, as the equipment information. In this case, the second wireless terminal device performs a different type of measurement from the measurement by the first wireless terminal device 151.

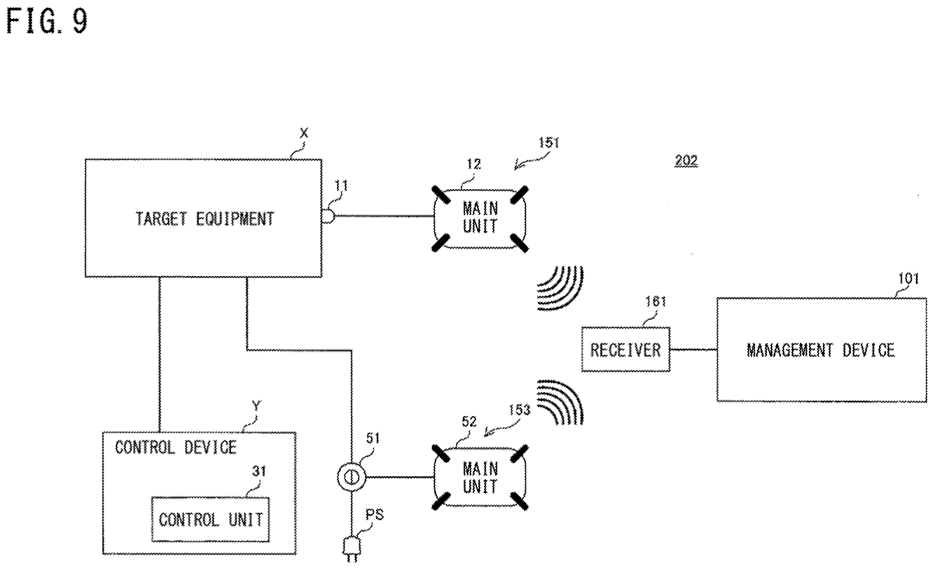

FIG. 9 is a diagram showing the configuration of a management system according to modification 1 of the embodiment of the present disclosure.

With reference to FIG. 9, a management system 202 includes a second wireless terminal device 153 in place of the second wireless terminal device 152 shown in FIG. 1.

The second wireless terminal device 153 is, for example, a clamp-type current sensor, and includes a core portion 51 and a main unit 52. The core portion 51 grasps an electric wire connecting the target equipment X and a power plug PS, for example. The main unit 52 measures the value of current flowing through the target equipment X by measuring current generated in a coil wound on the core portion 51, and transmits, as the equipment information, information indicating the measurement result to the management device 101 via the receiver 161.

Instead of the clamp-type current sensor, the second wireless terminal device 153 may be, for example, a current sensor to be directly connected to the electric wire connecting the target equipment X and the power plug PS. In a case of using such a current sensor, it is possible to measure a minute current value flowing through the electric wire and outputted in a range of 4 mA to 20 mA, for example.

The second wireless terminal device 153 may be a temperature sensor for measuring the temperature of the target equipment X, or a humidity sensor for measuring the humidity of the target equipment X, for example.

The second wireless terminal device 153 may be configured to acquire a result of measurement for the target equipment X performed by another device, and transmit equipment information indicating the acquired measurement result to the management device 101 via the receiver 161.

With reference to FIG. 2 again, when having received the measurement information transmitted from the receiver 161, the acquisition unit 41 in the management device 101 stores the received measurement information and the present time in the storage unit 43. In addition, when having received the equipment information transmitted from the receiver 161, the acquisition unit 41 stores the received equipment information and the present time in the storage unit 43.

The processing unit 42 performs processing of extracting some of the plural pieces of measurement information stored in the storage unit 43, at the timing based on the equipment information received by the acquisition unit 41.

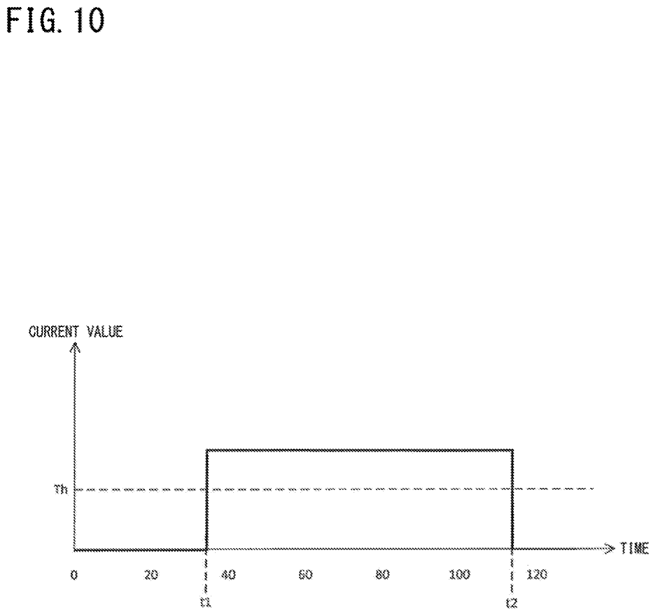

FIG. 10 shows a measurement result based on the equipment information received by the management device shown in FIG. 9. In the graph shown in FIG. 10, the horizontal axis indicates the time, and the vertical axis indicates the current value.

With reference to FIG. 10, specifically, it is assumed that the current values indicated by plural pieces of equipment information corresponding to a plurality of times included within a period from time t1 to time t2 are greater than a threshold Th. In this case, the processing unit 42 detects the time t1 as the operation start timing of the target equipment X, and detects the time t2 as the operation stop timing of the target equipment X.

In addition, the processing unit 42 extracts one or plural pieces of measurement information corresponding to the times included in the period from time t1 to time t2, from among the plural pieces of measurement information stored in the storage unit 43. Then, the processing unit 42 stores extraction information including the extracted one or plural pieces of measurement information, in the storage unit 43.

The detection unit 44 acquires the extraction information stored in the storage unit 43, at regular or irregular intervals, and detects abnormality of the target equipment X on the basis of the acquired extraction information.

The other configurations and operations are the same as those in the management system 201 shown in FIG. 1, and therefore, the detailed description thereof is not repeated here.

As described above, in the management system 201 according to modification 1 of the embodiment of the present disclosure, the equipment information indicates a result obtained by performing, for the target equipment X, a different type of measurement from the measurement indicated by the measurement information. The management device 101 performs processing of extracting a part of the measurement information on the basis of a result of comparison between the measurement result indicated by the equipment information and the predetermined threshold Th.

With this configuration, it is possible to use a certain type of measurement information for the timing setting for the processing of extracting measurement information about the target.

### Modification 2

In the example shown in FIG. 1, the management device 101 in the management system 201 performs processing of extracting a part of measurement information on the basis of the time at which the equipment information transmitted from the receiver 161 has been received. However, without limitation to such a configuration, the management system 201 may have the following configuration.

When having received the measurement information transmitted from the first wireless terminal device 151, the receiver 161 adds, for example, time information which is the present time, and the number of times of relaying, to the received measurement information. Then, the receiver 161 transmits the measurement information to which the present time and the number of times of relaying have been added, to the management device 101.

The number of times of relaying is the number of times the measurement information has been relayed between the first wireless terminal device 151 and the management device 101. That is, the receiver 161 that has received the measurement information transmitted from the first wireless terminal device 151 adds “1” as the number of times of relaying, to the measurement information.

One or a plurality of relays (not shown) may be provided between the first wireless terminal device 151 and the receiver 161. In this case, the relay that has directly received the measurement information transmitted from the first wireless terminal device 151 adds the present time and the number of times of relaying, “1”, to the measurement information, and transmits the measurement information to which the time information and the number of times of relaying have been added, to another relay or the receiver 161.

The other relay transmits, to still another relay or the receiver 161, the measurement information for which the number of times of relaying has been incremented by one, without adding the time information to the measurement information. The receiver 161 transmits, to the management device 101, the measurement information for which the number of times of relaying has been incremented by one, without adding the time information to the measurement information.

In addition, when having received the equipment information transmitted from the second wireless terminal device 152, the receiver 161 adds, for example, the time information which is the present time and the number of times of relaying, to the equipment information, as in the case of receiving the measurement information from the first wireless terminal device 151. Then, the receiver 161 transmits the equipment information to which the present time and the number of times of relaying have been added, to the management device 101.

In a case where one or a plurality of relays are provided between the second wireless terminal device 152 and the receiver 161, the relay that has directly received the equipment information transmitted from the second wireless terminal device 152 adds the time information and the number of times of relaying, “1”, to the equipment information, and transmits the equipment information to which the time information and the number of times of relaying have been added, to another relay or the receiver 161.

The other relay transmits, to still another relay or the receiver 161, the equipment information for which the number of times of relaying has been incremented by one, without adding the time information to the equipment information. The receiver 161 transmits, to the management device 101, the equipment information for which the number of times of relaying has been incremented by one, without adding the time information to the equipment information.

The management device 101 detects the operation start timing and the operation stop timing of the target equipment X on the basis of the time information included in the equipment information received from the receiver 161.

More specifically, for example, the processing unit 42 in the management device 101 confirms the plural pieces of equipment information stored in the storage unit 43, and detects the time information included in the first equipment information in which the contact information has been switched from “0” to “1”, as the operation start timing of the target equipment X. In addition, for example, the processing unit 42 detects the time information included in the first equipment information in which the contact information has been switched from “1” to “0”, as the operation stop timing of the target equipment X.

Then, the processing unit 42 extracts the measurement information corresponding to the period from the operation start timing to the operation stop timing of the target equipment X, from among the plural pieces of measurement information stored in the storage unit 43.

The receiver 161 may not necessarily have a function of adding the time information and the number of times of relaying to the measurement information and adding the time information and the number of times of relaying to the equipment information. In a case where the time information and the number of times of relaying are included in the equipment information from the receiver 161, i.e., in a case where the equipment information has been received via the relay, the management device 101 detects the operation start timing and the operation stop timing of the target equipment X on the basis of the time information included in the equipment information, as described above.

On the other hand, in a case where the time information and the number of times of relaying are not included in the equipment information from the receiver 161, i.e., in a case where the equipment information has been received not via the relay, the management device 101 detects the operation start timing and the operation stop timing of the target equipment X on the basis of the time at which the equipment information has been received.

In addition, in a case where the time information and the number of times of relaying are included in the measurement information from the receiver 161, i.e., in a case where the measurement information has been received via the relay, the management device 101 extracts the measurement information corresponding to the period from the operation start timing to the operation stop timing of the target equipment X, on the basis of the time information included in the measurement information.

On the other hand, in a case where the time information and the number of times of relaying are not included in the measurement information from the receiver 161, i.e., in a case where the measurement information has been received not via the relay, the management device 101 extracts the measurement information corresponding to the period from the operation start timing to the operation stop timing of the target equipment X, on the basis of the time at which the measurement information has been received from the receiver 161.

The management device 101 may be configured to directly receive the measurement information transmitted from the first wireless terminal device 151 and the equipment information transmitted from the second wireless terminal device 152.

In this case, the time information and the number of times of relaying are not included in the received equipment information, and therefore the management device 101 detects the operation start timing and the operation stop timing of the target equipment X on the basis of the time at which the equipment information has been received from the second wireless terminal device 152. Then, the management device 101 extracts the measurement information corresponding to the period from the operation start timing to the operation stop timing of the target equipment X, on the basis of the time at which the measurement information has been received from the first wireless terminal device 151.

The other configurations and operations are the same as those in the management system 201 shown in FIG. 1, and therefore, the detailed description thereof is not repeated here.

As described above, in the management system 201 according to modification 2 of the embodiment of the present disclosure, the receiver 161 receives the equipment information from the second wireless terminal device 152, adds the time information to the received equipment information, and transmits the resultant equipment information to the management device 101. The management device 101 performs processing of extracting a part of the measurement information on the basis of the time information included in the equipment information that allows recognition of operation start of the target equipment X, and the time information included in the equipment information that allows recognition of operation stop of the target equipment X.

For example, in a configuration in which the operation start timing and the operation stop timing of the target equipment X are detected using the time at which the equipment information is received by the management device 101, if a long time is required until the equipment information arrives at the management device 101, error between the operation start timing and the operation stop timing detected by the management device 101 and the actual operation start timing and operation stop timing increases. In contrast, in the configuration of using the time at which the equipment information has been received by the receiver 161 as described above, such error is reduced, and the operation start timing and the operation stop timing of the target equipment X can be detected with higher accuracy.

A part or the entirety of the functions of the management device 101 according to the embodiment of the present disclosure may be provided through cloud computing. That is, the management device 101 according to the embodiment of the present disclosure may be configured from a plurality of cloud provider servers or the like.

It is noted that the above embodiments are merely illustrative in all aspects and should not be recognized as being restrictive. The scope of the present invention is defined by the scope of the claims rather than the above description, and is intended to include meaning equivalent to the scope of the claims and all modifications within the scope.

The above description includes the features in the additional notes below.

[Additional Note 1]

A management system including: a first wireless terminal device configured to acquire and transmit measurement information indicating a result of measurement for target equipment;

a second wireless terminal device configured to acquire and transmit equipment information about operation of the target equipment; and

a management device configured to acquire the measurement information and the equipment information and perform processing of extracting a part of the measurement information on the basis of the equipment information, wherein

the second wireless terminal device includes a contact,

the contact is switched to a closed state when the target equipment starts operation, and is switched to an opened state when the target equipment stops operation,

the second wireless terminal device transmits information indicating a state of the contact, as the equipment information, and

the management device detects an operation start timing and an operation stop timing of the target equipment on the basis of the equipment information transmitted from the second wireless terminal device, and extracts, from the acquired measurement information, information corresponding to a period from the detected operation start timing to the detected operation stop timing.

[Additional Note 2]

A management device including:

an acquisition unit configured to acquire measurement information indicating a result of measurement for target equipment, and equipment information about operation of the target equipment; and

a processing unit configured to perform processing of extracting a part of the measurement information acquired by the acquisition unit, on the basis of the equipment information acquired by the acquisition unit, wherein

the equipment information indicates a state of a contact of a second wireless terminal device connected to the target equipment,

the contact is switched to a closed state when the target equipment starts operation, and is switched to an opened state when the target equipment stops operation, and

the processing unit detects an operation start timing and an operation stop timing of the target equipment on the basis of the equipment information, and extracts, from the measurement information acquired by the acquisition unit, information corresponding to a period from the detected operation start timing to the detected operation stop timing.

### REFERENCE SIGNS LIST

11 detection element

12 main unit

21, 52 main unit

41 acquisition unit

42 processing unit

43 storage unit

44 detection unit

51 core portion

101 management device

151 first wireless terminal device

152, 153 second wireless terminal device

161 receiver (relay)

201, 202 management system

P contact

PS power plug

X target equipment

Y control device

1. A management system comprising:
a first wireless terminal device configured to acquire and transmit measurement information indicating a result of measurement for target equipment;
a second wireless terminal device configured to acquire and transmit equipment information about operation of the target equipment; and
a management device configured to acquire the measurement information and the equipment information and perform processing of extracting a part of the measurement information on the basis of the equipment information.

2. The management system according to claim 1, wherein
the second wireless terminal device includes a contact, and
information that allows recognition of operation start and operation stop of the target equipment is given as the equipment information to the contact from outside of the second wireless terminal device.

3. The management system according to claim 2, wherein
the management device performs processing of extracting a part of the measurement information on the basis of a time at which the equipment information that allows recognition of operation start of the target equipment has been acquired, and a time at which the equipment information that allows recognition of operation stop of the target equipment has been acquired.

4. The management system according to claim 2, further comprising one or a plurality of relays configured to relay information between the second wireless terminal device and the management device, wherein
the relay receives the equipment information from the second wireless terminal device, adds time information to the received equipment information, and transmits resultant equipment information to another device, and
the management device performs processing of extracting a part of the measurement information on the basis of the time information included in the equipment information that allows recognition of operation start of the target equipment, and the time information included in the equipment information that allows recognition of operation stop of the target equipment.

5. The management system according to claim 1, wherein
the equipment information indicates a result obtained by performing, for the target equipment, a different type of measurement from the measurement indicated by the measurement information, and
the management device performs processing of extracting a part of the measurement information on the basis of a result of comparison between a measurement result indicated by the equipment information and a predetermined threshold.

6. The management system according to claim 1, wherein
the management device detects abnormality of the target equipment on the basis of the extracted information.

7. A management device comprising:
an acquisition unit configured to acquire measurement information indicating a result of measurement for target equipment, and equipment information about operation of the target equipment; and
a processing unit configured to perform processing of extracting a part of the measurement information acquired by the acquisition unit, on the basis of the equipment information acquired by the acquisition unit.

8. A management method in a management system including a first wireless terminal device, a second wireless terminal device, and a management device, the management method comprising the steps of:
the first wireless terminal device acquiring and transmitting measurement information indicating a result of measurement for target equipment;
the second wireless terminal device acquiring and transmitting equipment information about operation of the target equipment; and
the management device acquiring the measurement information and the equipment information and performing processing of extracting a part of the received measurement information on the basis of the acquired equipment information.

9. A non-transitory computer readable storage medium storing a management program for use in a management device, the management program causing a computer to function as:
an acquisition unit configured to acquire measurement information indicating a result of measurement for target equipment, and equipment information about operation of the target equipment; and
a processing unit configured to perform processing of extracting a part of the measurement information acquired by the acquisition unit, on the basis of the equipment information acquired by the acquisition unit.
